(19) United States
(12) Patent Application Publication
(10) Pub. No.: US 2017/0048944 A1
(43) Pub. Date: Feb. 16, 2017

(54) LIGHTING APPARATUS

(71) Applicant: SILICON WORKS CO., LTD., Daejeon (KR)

(72) Inventors: Yong Geun KIM, Suwon-si (KR); Yang June AN, Daejeon (KR)

(73) Assignee: SILICON WORKS CO., LTD., Daejeon (KR)

(21) Appl. No.: 15/228,542

(22) Filed: Aug. 4, 2016

(30) Foreign Application Priority Data
Aug. 13, 2015 (KR) 10-2015-0114487

(51) Int. Cl. H05B 33/08

(52) U.S. Cl. CPC H05B 33/0851

(57) ABSTRACT

Disclosed is a lighting apparatus using LEDs as a light source. The lighting apparatus may include: a dimming control unit configured to provide one of first and second control signals as a dimming control signal, the first control signal corresponding to a dimming signal inputted in response to connection of a dimmer, the second control signal corresponding to disconnection of the dimmer; and a driving current control circuit configured to control a driving current corresponding to light emission of a lighting unit in response to the dimming control signal of the dimming control unit.

### BACKGROUND

1. Technical Field

The present disclosure relates to a lighting apparatus, and more particularly, to a lighting apparatus using an LED as a light source.

2. Related Art

A lighting apparatus is designed to use a light source which exhibits high light emission efficiency using a small amount of energy, in order to reduce energy consumption. Representative examples of a light source used in the lighting apparatus may include an LED. The LED is differentiated from other light sources in terms of various aspects such as energy consumption, lifespan, and light quality.

However, since the LED is driven by a current, a lighting apparatus using the LED as a light source requires a number of additional circuits for driving a current. In order to solve the above-described problem, an AC direct-type lighting apparatus has been developed to provide an AC voltage to the LED.

The AC direct-type lighting apparatus is configured to convert an AC voltage into a rectified voltage, and drive a current using the rectified voltage such that the LED can emit light. Since the AC direct-type LED lighting apparatus uses a rectified voltage without using an inductor and capacitor, the AC direct-type LED lighting apparatus has a satisfactory power factor. The rectified voltage indicates a voltage obtained by full-wave rectifying an AC voltage.

The AC direct-type lighting apparatus includes one or more LED groups, and each of the LED groups includes one or more LEDs, and emits light in response to a change of the rectified voltage.

The AC direct-type lighting apparatus may be connected to a dimmer, when illuminance control is required. The dimmer may include various types of dimmers such as an analog dimmer for providing a DC voltage and a digital dimmer for providing a pulse which is a pulse width modulated signal.

The AC direct-type lighting apparatus includes a driving circuit which provides a current path corresponding to light emission of one or more LED groups and regulates a driving current. The driving circuit receives a dimming control signal from a dimming control unit which is separately configured, and controls a driving current. The dimming control unit is connected to the dimmer, receives a dimming signal of the dimmer, and provides a dimming control signal corresponding to the dimming signal to the driving circuit.

When the dimmer is not connected to the AC direct-type lighting apparatus, a dimming signal input terminal of the dimming control unit may float, the dimmer signal input terminal being used for connecting the dimmer. In order to prevent the float, the dimming signal input terminal of the dimming control unit requires additional circuit processing such as short. As a result, the float of the dimming signal input terminal of the dimming control unit can be prevented.

However, when the circuit processing state of the dimming signal input terminal of the dimming control unit is changed according to whether the dimmer is connected, it may cause inconvenience during a design and manufacturing process of the lighting apparatus, and serve as a constraint in embodying the lighting apparatus in various manners.

Thus, there is a demand for an AC direct-type lighting apparatus which is designed to operate by determining a connection state of a dimmer without a separate circuit processing operation.

### SUMMARY

Various embodiments are directed to a lighting apparatus which capable of detecting connection of a dimmer and controlling a driving current using a preset constant voltage in response to light emission of LEDs, when the dimmer is not connected.

In an embodiment, a lighting apparatus may include: a driving circuit configured to provide a current path for sequential light emission of LED groups in response to changes of a rectified voltage; a dimming control unit configured to provide one of first and second control signals as a dimming control signal, the first control signal corresponding to a dimming signal inputted in response to connection of a dimmer, the second control signal corresponding to disconnection of the dimmer; and a driving current control circuit configured to control the amount of driving current flowing through the current path in response to the dimming control signal of the dimming control unit.

### BRIEF DESCRIPTION OF THE DRAWINGS

FIG. 1 is a block diagram illustrating a lighting apparatus according to an embodiment of the present invention.

FIG. 2 is a circuit diagram illustrating a driving circuit of FIG. 1.

FIG. 3 is a graph illustrating changes of a driving current according to changes of a rectified voltage.

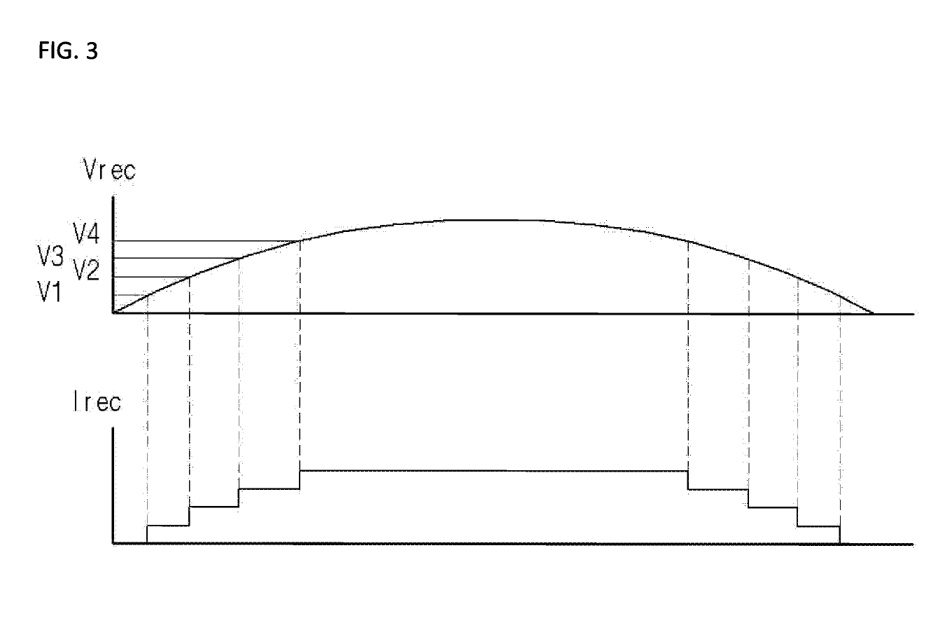

FIG. 4 is a circuit diagram illustrating a dimming control unit of FIG. 1.

FIG. 5 is a graph for describing illuminance changes by the dimming control unit of FIG. 4.

FIG. 6 is a circuit diagram illustrating another embodiment of the dimming control unit of FIG. 1.

FIG. 7 is a block diagram illustrating a lighting apparatus according to another embodiment of the present invention.

FIG. 8 is a circuit diagram illustrating a driving circuit of FIG. 7.

FIG. 9 is a circuit diagram illustrating another embodiment of the driving circuit of FIG. 7.

FIG. 10 is a circuit diagram illustrating still another embodiment of the driving circuit of FIG. 7.

### DETAILED DESCRIPTION

Hereafter, embodiments of the present invention will be described in detail with reference to the accompanying drawings. The terms used in the present specification and claims are not limited to typical dictionary definitions, but must be interpreted into meanings and concepts which coincide with the technical idea of the present invention.

Embodiments described in the present specification and configurations illustrated in the drawings are preferred embodiments of the present invention, and do not represent the entire technical idea of the present invention. Thus, various equivalents and modifications capable of replacing the embodiments and configurations may be provided at the point of time that the present application is filed.

A lighting apparatus according to an embodiment of the present invention may be configured to detect a connection state of a dimmer for controlling illuminance, and fix illuminance using a preset constant voltage when the dimmer is not connected.

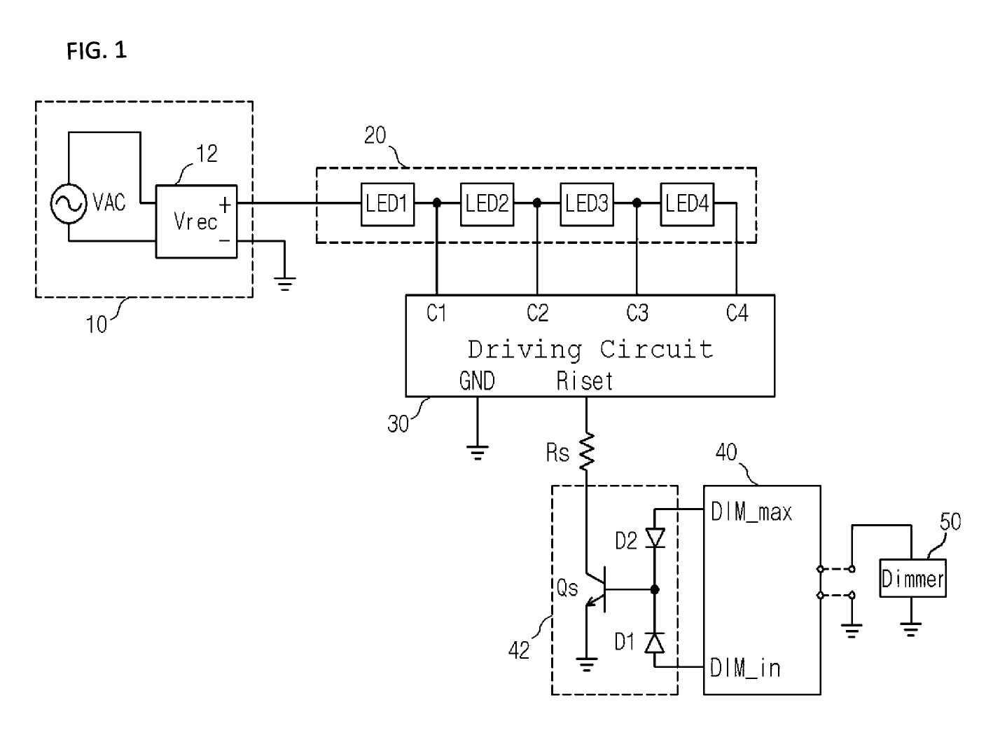

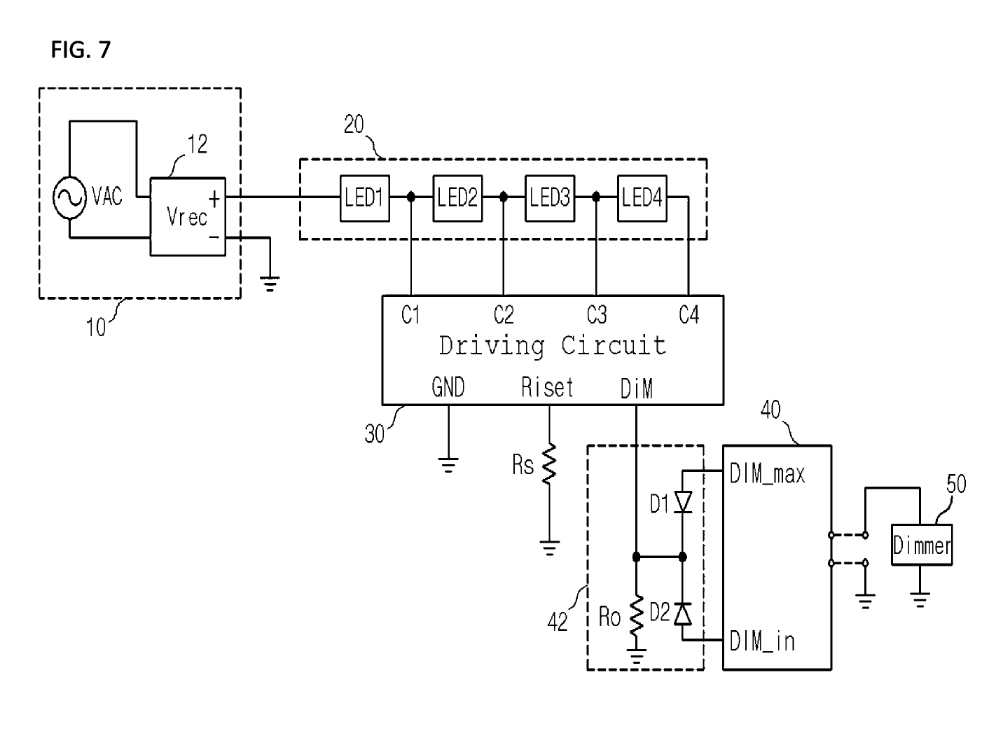

The lighting apparatus may include a variety of methods for applying a dimming control signal to a driving circuit 30 in order to control illuminance. In an embodiment, the lighting apparatus may control a current amount of a sensing resistor Rs connected to a current path of the driving circuit 30, in order to control illuminance. In another embodiment, the driving circuit 30 may have a dimming control terminal DIM, and control an internal driving current of the driving circuit in response to a dimming control signal applied to the dimming control terminal DIM, in order to control illuminance. The former embodiment may correspond to an embodiment of FIG. 1, and the latter embodiment may correspond to an embodiment of FIG. 7.

Referring to FIG. 1, a lighting apparatus according to an embodiment of the present invention will be described.

In FIG. 1, the lighting apparatus according to the present embodiment includes a power supply unit 10, a lighting unit 20, a driving circuit 30, a dimming control unit 40 and a driving current control circuit 42. The dimming control unit 40 may have a dimming signal input terminal which is electrically connected to an external dimmer 50.

The power supply unit 10 may be configured to provide a rectified voltage Vrec. For this operation, the power supply unit 10 may include an AC power supply VAC and a rectifier 12.

The AC power supply VAC may be implemented with a common AC power supply, and provide an AC voltage. The rectifier 12 may full-wave rectify an AC voltage of the AC power supply VAC, and output the rectified voltage Vrec. The rectifier 12 may have a typical bridge diode structure.

The rectified voltage Vrec provided from the power supply unit 10 has a ripple corresponding to a half cycle of the rectified voltage Vrec. Hereafter, in the present embodiment, a change of the rectified voltage Vrec is defined as an increase/decrease of the ripple.

The lighting unit 20 emits light in response to the rectified voltage Vrec, and includes LEDs. The plurality of LEDs included in the lighting unit 20 may be divided into a plurality of LED groups, and FIG. 1 illustrates that the lighting unit 20 includes four LED groups connected in series. That is, the lighting unit 20 includes the LED groups LED1 to LED4 connected in series. The number of LED groups included in the lighting unit 20 may be set to various values according to a designer's intention.

Each of the LED groups included in the lighting unit 20 may include one or more LEDs or a plurality of LEDs connected in series, parallel or series-parallel.

The voltage at which an LED group emits light may be defined as a light emission voltage. More specifically, the voltage at which the LED group LED1 emits light may be defined as a light emission voltage V1 of the LED group LED1, the voltage at which the LED groups LED1 and LED2 emit light may be defined as a light emission voltage V2 of the LED group LED2, the voltage at which the LED groups LED1 to LED3 emit light may be defined as a light emission voltage V3 of the LED group LED3, and the voltage at which the LED groups LED1 to LED4 emit light may be defined as a light emission voltage V4 of the LED group LED4.

The driving circuit 30 performs current regulation for light emission of the lighting unit 20, and provides a current path for sequential emission.

More specifically, the driving circuit 30 may be configured to provide a current path which is changed in response to light emissions of the LED groups LED1 to LED4 of the lighting unit 20 according to changes of the rectified voltage Vrec, and perform current regulation on the current path.

For this operation, the driving circuit 30 includes terminals C1 to C4, a sensing resistor terminal Riset and a ground terminal GND. The terminals C1 to C4 are connected to the respective output terminals of the LED groups LED1 to LED4 included in the lighting unit 20 and configured to form a channel, the sensing resistor terminal Riset is configured to connect a current path formed in the driving circuit 30 to a sensing resistor, and the ground terminal GND is used for grounding.

The driving circuit 30 uses a sensing voltage provided through the sensing resistor terminal Riset in order to provide a current path.

The driving circuit 30 compares the sensing voltage to reference voltages which are internally provided in response to the respective LED groups LED1 to LED4. According to the comparison results between the sensing voltage and the reference voltages, the driving circuit 30 may provide current paths connecting the sensing resistor terminal Riset to the terminals C1 to C4, respectively.

The lighting unit 20 sequentially emits light in response to changes of the rectified voltage Vrec which periodically rises and falls. When the rectified voltage Vrec rises, the number of LED groups which sequentially emit light is increased, and when the rectified voltage Vrec falls, the number of LED groups which sequentially emit light is decreased. The driving circuit 30 provides a current path which is changed in response to sequential light emission of the lighting unit 20, and the driving current on the current path for sequential light emission is changed in a stepwise manner.

The dimming control unit 40 provides one of first and second dimming control signals DIM_in and DIM_max as a dimming control signal to a dimming signal input terminal to which a dimming signal is inputted in response to connection of the dimmer 50. The first dimming control signal DIM_in corresponds to the dimming signal, and the second dimming control signal DIM_max corresponds to disconnection of the dimmer 50.

The driving current control circuit 42 controls a driving current corresponding to light emission of the lighting unit 20 including LEDs, in response to the dimming control signal of the dimming control unit 40. For this operation, the driving current control circuit 42 of FIG. 1 is connected in series to the sensing resistor Rs through which the driving current outputted from the driving circuit 30 flows.

The driving current control circuit 42 has an NPN bipolar transistor Qs connected between the sensing resistor Rs and a ground, and one of the first and second dimming control signals DIM_in and DIM_max provided from the dimming control unit 40 is applied as the dimming control signal to the base of the NPN bipolar transistor Qs.

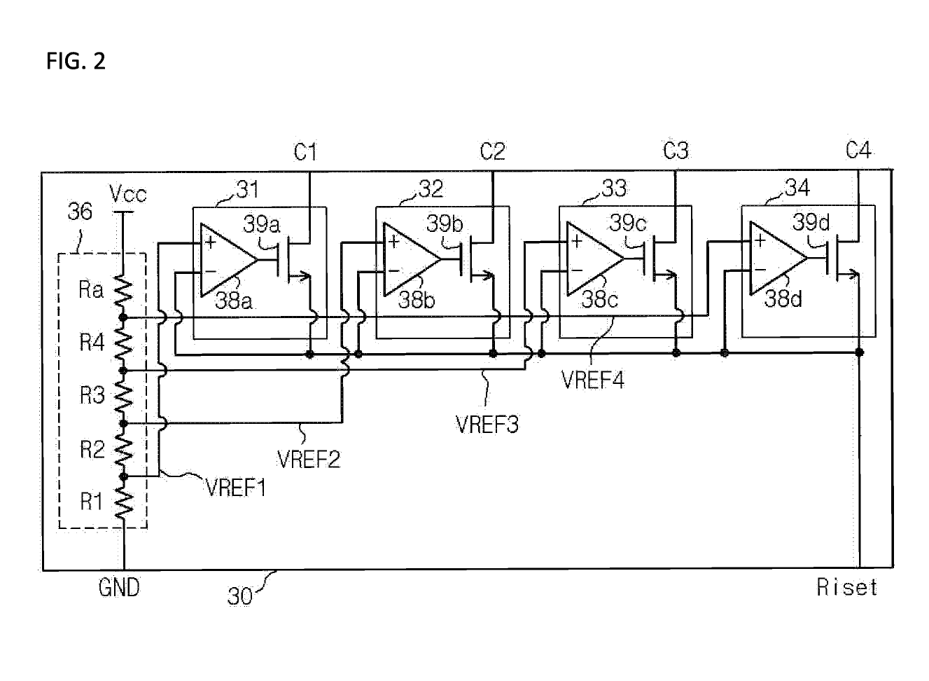

The driving circuit 30 of FIG. 1 may be described with reference to FIG. 2.

The driving circuit 30 includes a plurality of switching circuits 31 to 34 and a reference voltage supply unit 36. The plurality of switching circuits 31 to 34 provide a current path for the LED groups LED1 to LED4, and the reference voltage supply unit 36 provides the reference voltages VREF1 to VREF4.

The reference voltage supply unit 36 may be configured to provide the reference voltages VREF1 to VREF4 having different levels according to a designer's intention.

The reference voltage supply unit 36 includes a plurality of resistors connected in series, for example, and the plurality of resistors connected in series receive a constant voltage Vcc and are connected to the ground terminal GND. The reference voltage supply unit 36 may be configured to output the reference voltages VREF1 to VREF4 having different levels to nodes between the respective resistors. In another embodiment, the reference voltage supply unit 36 may include independent voltage supply sources for providing the respective reference voltages VREF1 to VREF4 having different levels.

Among the reference voltages VREF1 to VREF4 having different levels, the reference voltage VREF1 may have the lowest voltage level, and the reference voltage VREF4 may have the highest voltage level. The voltage level may gradually increase in order of the reference voltages VREF1, VREF2, VREF3, and VREF4.

The reference voltage VREF1 has a level for turning off the switching circuit 31 at the point of time that the LED group LED2 emits light. More specifically, the reference voltage VREF1 may be set to a lower level than the sensing voltage which is formed in the sensing resistor Rs at the point of time that the LED group LED2 emits light.

The reference voltage VREF2 has a level for turning off the switching circuit 32 at the point of time that the LED group LED3 emits light. More specifically, the reference voltage VREF2 may be set to a lower level than the sensing voltage which is formed in the sensing resistor Rs at the point of time that the LED group LED3 sequentially emits light.

The reference voltage VREF3 has a level for turning off the switching circuit 33 at the point of time that the LED group LED4 emits light. More specifically, the reference voltage VREF3 may be set to a lower level than the sensing voltage which is formed in the sensing resistor Rs at the point of time that the LED group LED4 emits light.

The reference voltage VREF4 may be set in such a manner that a current flowing through the sensing resistor Rs becomes a predetermined constant current in the upper limit level region of the rectified voltage Vrec.

The switching circuits 31 to 34 are commonly connected to the sensing resistor Rs, in order to perform current regulation and form a current path.

The switching circuits 31 to 34 compare the sensing voltage of the sensing resistor Rs to the reference voltages VREF1 to VREF4 of the reference voltage supply unit 36, respectively, and form a current path for light emission of the lighting unit 20.

Each of the switching circuits 31 to 34 receives a high-level reference voltage, as the switching circuit is connected to an LED group remote from the position to which the rectified voltage Vrec is applied.

The switching circuits 31 to 34 may include comparators 38a to 38d and switching elements, respectively, and the switching elements may include NMOS transistors 39a to 39d, respectively.

Each of the comparators 38a to 38d of the switching circuits 31 to 34 has a positive input terminal (+) configured to receive a reference voltage, a negative input terminal (−) configured to receive a sensing voltage, and an output terminal configured to output a result obtained by comparing the reference voltage and the sensing voltage.

The NMOS transistors 39a to 39d of the respective switching circuits 31 to 34 perform a switching operation according to the outputs of the comparators 38a to 38d, which are applied through the gates thereof. The drains of the respective NMOS transistors 39a to 39d and the negative input terminals (−) of the respective comparators 38a to 38d are commonly connected to the sensing resistor Rs.

According to the above-described configuration, the sensing resistor Rs may apply the sensing voltage to the negative input terminals (−) of the comparators 38a to 38d, and provide current paths corresponding to the NMOS transistors 39a to 39d of the respective switching circuits 31 to 34.

In the lighting apparatus according to the embodiment of the present invention, the LED groups LED1 to LED4 may sequentially emit light in response to changes of the rectified voltage Vrec, and the current path corresponding to the sequential light emissions of the LED groups LED1 to LED4 may be provided through the driving circuit 30.

Hereafter, the operation of the lighting apparatus according to the embodiment of the present invention, which is configured as illustrated in FIGS. 1 and 2, will be described. For convenience of description, suppose that the NPN bipolar transistor Qs of the driving current control circuit 42 guarantees a maximum driving current flow.

When the rectified voltage Vrec is in the initial state, all of the switching circuits 31 to 34 maintain a turn-on state because the reference voltages VREF1 to VREF4 applied to the positive input terminals (+) thereof are higher than the sensing voltage of the resistor Rs, which is applied to the negative input terminals (−) thereof. However, since the rectified voltage Vrec has a level which is not enough to turn on the LED groups LED1 to LED4, the LED groups LED1 to LED4 do not emit light.

Then, when the rectified voltage Vrec rises to reach the light emission voltage V1, the LED group LED1 emits light. When the LED group LED1 of the lighting unit 20 emits light, the switching circuit 31 connected to the LED group LED1 provides a current path for light emission.

When the rectified voltage Vrec reaches the light emission voltage V1 such that the LED group LED1 emits light and a current path is formed through the switching circuit 31, the driving current Irec of which the level increased to a predetermined level flows along a path passing through the LED group LED1, the switching circuit 31 of the driving circuit 30 and the sensing resistor Rs.

Then, when the rectified voltage Vrec continuously rises to reach the light emission voltage V2, the LED group LED2 emits light. When the LED group LED2 of the lighting unit 20 emits light, the switching circuit 32 connected to the LED group LED2 provides a current path for light emission.

When the rectified voltage Vrec reaches the light emission voltage V2 such that the LED group LED2 emits light and the current path is formed through the switching circuit 32, the level of the sensing voltage of the sensing resistor Rs rises. At this time, the sensing voltage has a higher level than the reference voltage VREF1. Therefore, the NMOS transistor 39a of the switching circuit 31 is turned off by an output of the comparator 38a. That is, the switching circuit is turned off, and the switching circuit 32 provides a current path corresponding to light emission of the LED group LED2. At this time, the LED group LED1 also maintains the light emitting state, and the level of the driving current Irec rises to the level regulated by the switching circuit 32.

Then, when the rectified voltage Vrec continuously rises to reach the light emission voltage V3, the LED group LED3 emits light. When the LED group LED3 emits light, the switching circuit 33 connected to the LED group LED3 provides a current path for light emission.

When the rectified voltage Vrec reaches the light emission voltage V3 such that the LED group LED3 sequentially emits light and the current path is formed through the switching circuit 33, the level of the sensing voltage of the sensing resistor Rs rises. At this time, the sensing voltage has a higher level than the reference voltage VREF2. Therefore, the NMOS transistor 39b of the switching circuit 32 is turned off by an output of the comparator 38b. That is, the switching circuit 32 is turned off, and the switching circuit 33 provides a current path corresponding to the light emission of the LED group LED3. At this time, the LED groups LED1 and LED2 also maintain the light emitting state, and the level of the driving current Irec rises to the level regulated by the switching circuit 33.

Then, when the rectified voltage Vrec continuously rises to reach the light emission voltage V4, the LED group LED4 emits light. When the LED group LED4 emits light, the switching circuit 34 connected to the LED group LED4 provides a current path for light emission.

When the rectified voltage Vrec reaches the light emission voltage V4 such that the LED group LED4 sequentially emits light and the current path is formed through the switching circuit 34, the level of the sensing voltage of the sensing resistor Rs rises. At this time, the sensing voltage has a higher level than the reference voltage VREF3. Therefore, the NMOS transistor 39c of the switching circuit 33 is turned off by an output of the comparator 38c. That is, the switching circuit 33 is turned off, and the switching circuit 34 provides a current path corresponding to the light emission of the LED group LED4. At this time, the LED groups LED1 to LED3 also maintain the light emitting state, and the level of the driving current Irec rises to the level regulated by the switching circuit 34.

The light emission of the LED group LED4 is maintained until the rectified voltage Vrec rises to the maximum level and then falls to reach the light emission voltage V4.

Then, when the rectified voltage Vrec falls, the switching circuits 34 to 31 connected to the LED groups LED4 to LED1 are sequentially turned off, the LED groups LED4 to LED1 are sequentially turned off, and the driving current Irec decreases in a stepwise manner.

In the present embodiment, the dimming control unit 40 is configured to provide one of the first and second dimming control signals DIM_in and DIM_max as the dimming control signal to the driving current control circuit 42 according to the connection state of the dimmer 50. The first dimming control signal DIM_in corresponds to a dimming signal provided from the dimmer 50, and the dimming control signal DIM_max corresponds to a preset constant voltage.

The driving current control circuit 42 controls the driving current Irec outputted from the driving circuit 30 which provides a current path in response to light emission of the lighting unit 20. For this operation, the driving current control circuit 42 includes a current control element which is connected in series to the sensing resistor Rs connected to the driving current output terminal (sensing resistor terminal Riset) of the driving circuit 30, and the current control element controls the driving current Irec according to one of the first and second dimming control signals DIM_in and DIM_max provided from the dimming control unit 40.

The current control element may include the NPN bipolar transistor Qs.

The driving current control circuit 42 includes a diode D1 for transmitting the first dimming control signal DIM_in to the base of the NPN bipolar transistor Qs and a diode 92 for transmitting the second dimming control signal DIM_max corresponding to a preset constant voltage to the base of the NPN bipolar transistor Qs.

The dimming control unit 40 may be configured to provide the first and second dimming control signals DIM_in and DIM_max as DC voltages or pulse signals having a constant pulse width. In the present embodiment, suppose that the first and second dimming control signals DIM_in and DIM_max are provided as DC voltages, for convenience of description.

The dimming control unit 40 may provide the first dimming control signal DIM_in corresponding to the dimming signal of the dimmer 50 when the dimmer 50 is connected. When the dimmer 50 is not connected, the dimming control unit 40 may provide the second dimming control signal DIM_max at a level corresponding to the maximum value of the first dimming control signal DIM_in or the level that guarantees the maximum illuminance.

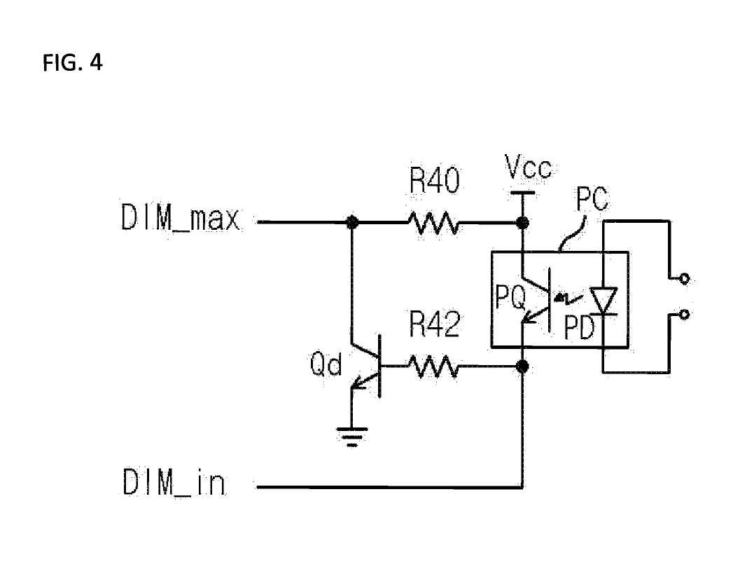

The dimming control unit 40 may be configured as illustrated in FIG. 4.

The dimming control unit 40 includes a first dimming control signal providing circuit and a second dimming control signal providing circuit. The first dimming control providing circuit receives a dimming signal of the connected dimmer 50 and provides the first dimming control signal DIM_in corresponding to the level of the dimming signal, and the second dimming control providing circuit provides the second dimming control signal DIM_max corresponding to preset illuminance when the first dimming control signal DIM_in is equal to or less than a preset level, in response to disconnection of the dimmer 50.

In FIG. 4, a photo coupler PC corresponds to the first dimming control signal providing circuit, and an NPN bipolar transistor Qd and resistors R40 and R42 correspond to the second dimming control signal providing circuit.

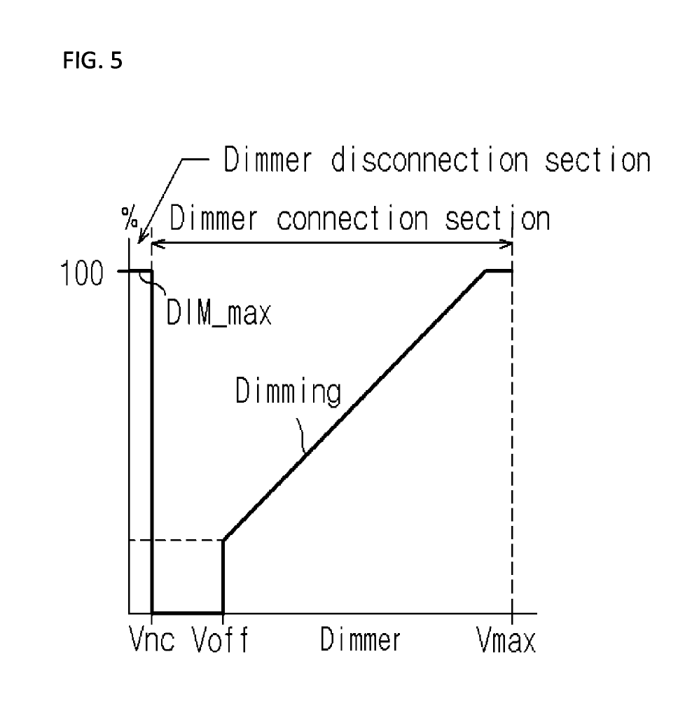

More specifically, the configuration and operation of the dimming control unit according to the embodiment of FIG. 4 will be described with reference to FIG. 5.

The photo coupler PC includes a photodiode PD and a phototransistor PQ. The photodiode PD emits light in response to a dimming signal of the dimmer 50, which is applied across the photodiode PD. The phototransistor PQ controls a current based on the constant voltage Vcc according to the amount of received light, which corresponds to the amount of light generated by the photodiode PD. As a result, the phototransistor PQ outputs the first dimming control signal DIM_in corresponding to the dimming signal.

The dimmer 50 provides a dimming signal having a level which is higher than a voltage Vnc and equal to or lower than a voltage Vmax. A dimming signal between the voltage Vnc and a voltage Voff is used for dimming off, and the driving current control circuit 42 controls the driving current Irec to turn off the lighting unit 20 according to the first dimming control signal DIM_in corresponding to the dimming signal.

When the first dimming control signal DIM_in retains the voltage Vnc or more, the NPN bipolar transistor Qd maintains the turn-on state. As a result, an output of the second dimming control signal DIM_max through the resistor R40 is blocked.

The NPN bipolar transistor Qd is turned off when the first dimming control signal DIM_in applied to the base through the resistor R42 is equal to or less than a preset level. As a result, the second dimming control signal DIM_max may be outputted through the resistor R40, while having the constant voltage level Vcc corresponding to the maximum value of the first dimming control signal DIM_in.

That is, when the phototransistor PQ of the photo coupler PC is turned off because the dimmer 50 is not connected, the second dimming control signal DIM_max corresponding to disconnection of the dimmer 50 may be outputted at the constant voltage level Vcc corresponding to the maximum value of the first dimming control signal DIM_in through the operation of the NPN bipolar transistor Qd.

The voltage Vnc which serves as a reference voltage for determining connection or disconnection of the dimmer 50 may be set to substantially 0V or a lower level than the voltage Voff for dimming off.

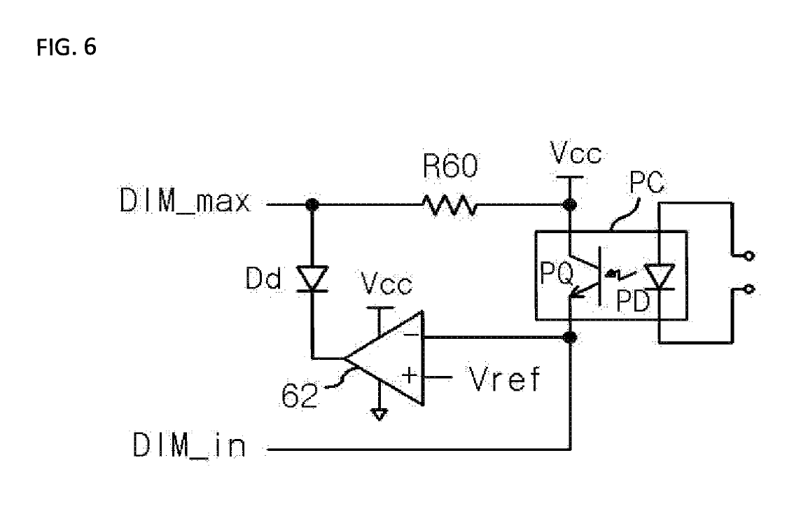

The dimming control unit 40 according to the present embodiment may be configured as illustrated in FIG. 6.

The dimming control unit of FIG. 6 may include a first dimming control signal providing circuit, a comparator 62, and a second dimming control signal providing circuit. The first dimming control signal providing circuit receives a dimming signal and provides a first dimming control signal DIM_in corresponding to the level of the dimming signal, the comparator 62 determines whether the first dimming control signal DIM_in is equal to or less than a preset reference voltage Vref, and the second dimming control signal providing circuit provides a second dimming control signal DIM_max corresponding to preset illuminance when the first dimming control signal DIM_in is equal to or less than the reference voltage Vref.

The first dimming control signal providing circuit may include a photo coupler PC, and the second dimming control signal providing circuit may include a diode Dd and a resistor R60.

More specifically, the configuration and operation of the dimming control unit 40 according to the embodiment of FIG. 6 will be described with reference to FIG. 5. Since the photo coupler PC is operated in the same manner as the embodiment of FIG. 4, the duplicated descriptions are omitted herein.

When the dimmer 50 provides a dimming signal having a level which is higher than the voltage Vnc and equal to or lower than the voltage Vmax, the first dimming control signal DIM_in corresponding to a dimming signal between the voltage Vnc and the voltage Voff is provided to the driving current control circuit 42 through the operation of the photo coupler PC, and the driving current control circuit 42 controls the driving current Irec outputted from the lighting unit 20.

At this time, since the first dimming control signal DIM_in applied to an inverting terminal (−) of the comparator retains a level equal to or higher than the reference voltage Vref applied to a non-inverting terminal (+) of the comparator 62, the comparator 62 outputs a ground voltage, and the second dimming control signal DIM_max falls to the ground level through the operation of the diode Dd.

When the phototransistor PQ of the photo coupler PC is turned off because the dimmer 50 is not connected, the voltage applied to the inverting terminal (−) of the comparator 62 becomes lower than the reference voltage Vref applied to the non-inverting terminal (+) of the comparator 620. At this time, the comparator 62 outputs the constant voltage Vcc, and the diode Dd is not operated because both ends thereof have no potential difference therebetween. Thus, the second dimming control signal DIM_max may be outputted at the constant voltage level Vcc corresponding to the maximum level of the first dimming control signal DIM_in.

In another embodiment, the driving circuit 30 may have a dimming control terminal DIM, and control an internal driving current of the driving circuit 30 in response to the dimming control signal applied to the dimming control terminal DIM, as illustrated in FIG. 7.

In the embodiment of FIG. 7, the dimming control unit 40 may be configured in the same manner as the embodiments of FIGS. 4 and 6. Thus, the detailed descriptions thereof are omitted herein.

In the embodiment of FIG. 7, the driving circuit 30 may have the dimming control terminal DIM, and control the internal driving current Irec according to a voltage applied to the dimming control terminal DIM.

The driving current control circuit 42 includes a resistor Ro to which the dimming control signal is applied, a diode D1 for transmitting the first dimming control signal DIM_in, and a diode D2 for transmitting the second dimming control signal DIM_max, and the resistor Ro, the diode D1 and the diode D2 are connected in parallel to the dimming control terminal DIM.

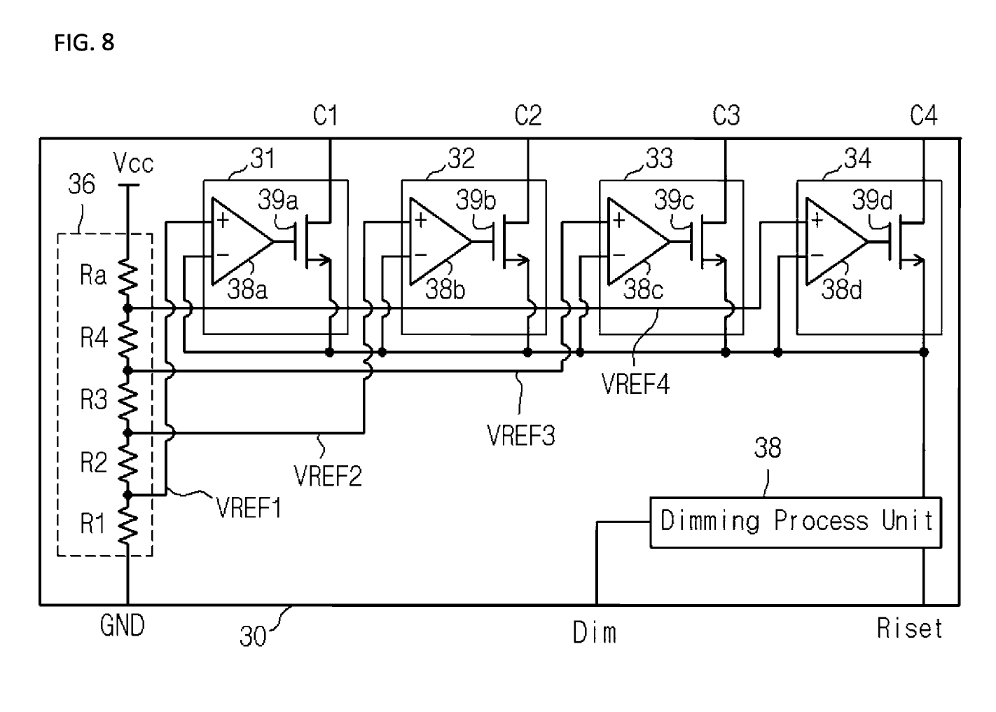

The driving circuit 30 may be configured as illustrated in FIG. 8.

Referring to FIG. 8, the driving circuit 30 may include a dimming processing unit 38 connected to the sensing resistor terminal Riset which is commonly connected to the switching circuits 31 to 34 for selectively providing a current path in response to light emission of the lighting unit 20, and the dimming processing unit 38 may control the amount of driving current Irec to be outputted, in response to the dimming control signal transmitted through the dimming control terminal DIM.

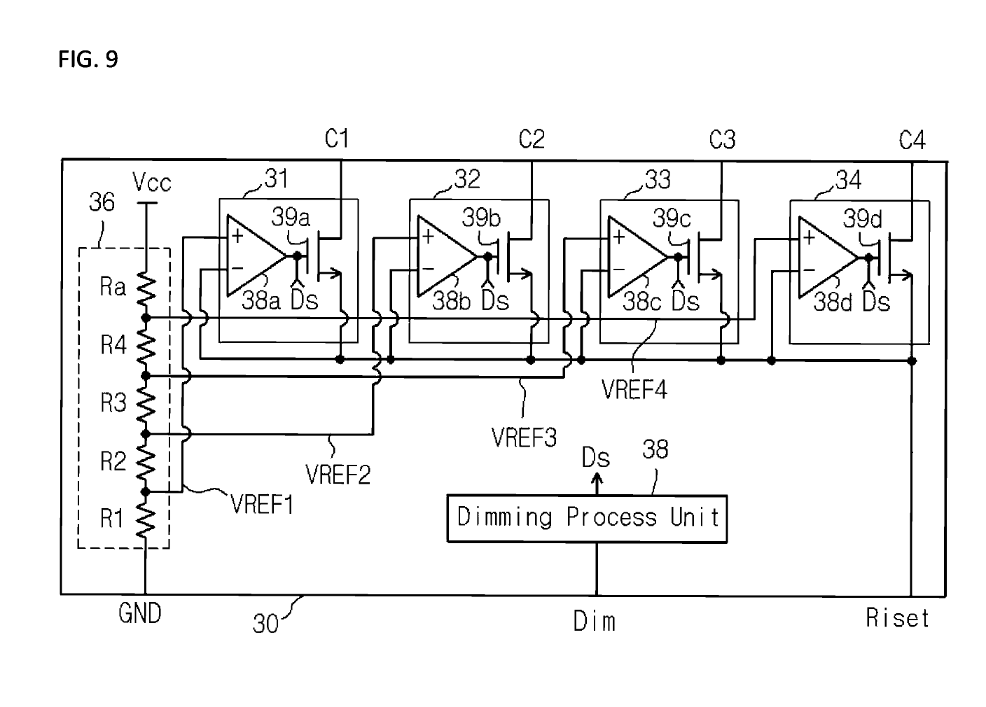

Furthermore, the driving circuit 30 may be configured as illustrated in FIG. 9.

Referring to FIG. 9, the driving circuit 30 includes a dimming processing unit 38 and switching circuits 31 to 34. The dimming processing unit 38 receives the dimming control signal through the sensing resistor terminal Riset, and the switching circuits 31 to 34 selectively provide a current path in response to light emission of the lighting unit 20. The dimming processing unit 38 is configured to control the amounts of driving currents Irec of the switching circuits 31 to 34 for forming a current path, in response to the dimming control signal.

More specifically, the dimming processing unit 38 may control the amounts of driving currents Irec by providing a control signal Ds corresponding to the dimming control signal to the gates of the NMOS transistors 39a to 39d of the respective switching circuits 31 to 34.

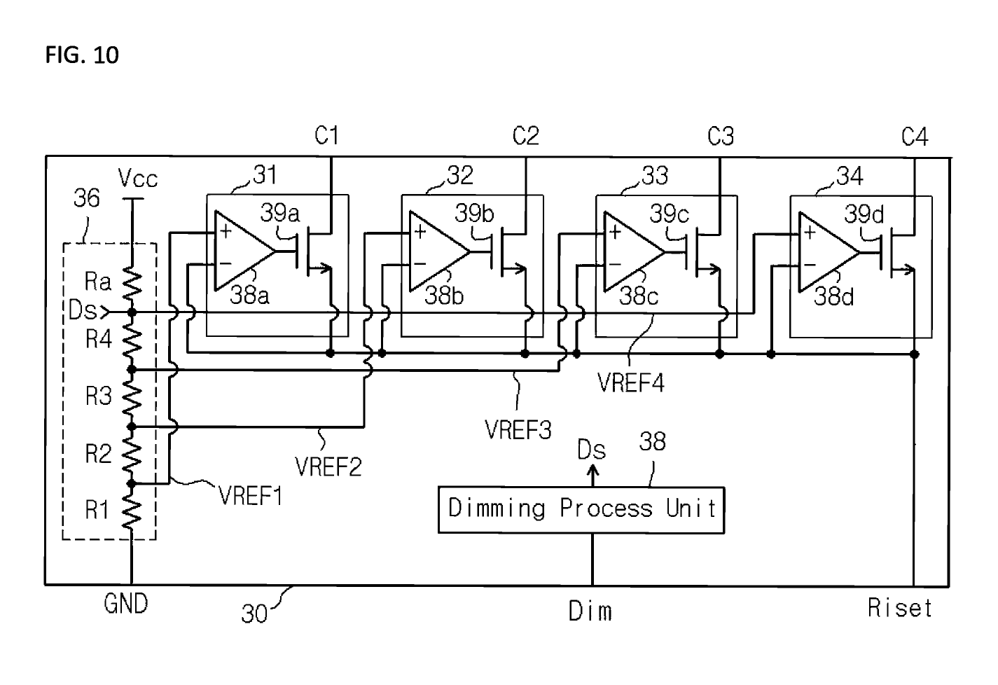

In addition, the driving circuit 30 may be configured as illustrated in FIG. 10.

Referring to FIG. 10, the driving circuit 30 includes a dimming processing unit 38 and a reference voltage supply unit 36. The dimming processing unit 38 receives the dimming control signal through the sensing resistor terminal Riset, and the reference voltage g supply unit 36 provides a reference voltage for forming a current path in response to light emission of the lighting unit 20. The reference voltage supply unit 36 includes resistors Ra and R1 to R4 which are connected in series to receive the constant voltage Vcc and the ground voltage thereacross, and output reference voltages Vref1 to Vref4 to nodes to which the resistors are connected, respectively. The dimming processing unit 38 is configured to change the levels of the reference voltages of the reference voltage supply unit 36 in response to the dimming control signal.

More specifically, the dimming processing unit 38 applies a control signal Ds corresponding to the dimming control signal to the node that outputs the highest reference voltage Vref4 of the reference voltage supply unit 36, and the reference voltage supply unit 36 may output the reference voltages Vref1 to Vref4 which are controlled according to level changes of the dimming control signal. As a result, the driving circuit 30 may control and output the driving current Irec according to a change of the dimming control signal.

In the embodiments of FIGS. 8 and 9, when the dimmer 50 is not connected, the driving circuit 30 may provide the second dimming control signal DIM_max corresponding to the maximum value of the first dimming control signal DIM_in to the dimming processing unit 38 through the dimming control terminal DIM.

Thus, when the dimmer 50 is not connected, the driving circuit 30 may control the driving current Irec to correspond to the maximum illuminance.

The lighting apparatus according to the embodiments of the present invention may automatically sense connection of the dimmer 50 and connect the driving current Irec. In particular, when the dimmer 50 is not connected, the lighting apparatus may control illuminance based on light emission of the LEDs, using the constant voltage.

Thus, the lighting apparatus may not require a design and manufacturing process considering disconnection of the dimmer 50. As long as the connection of the dimmer 50 is automatically sensed, the lighting apparatus may be embodied in various manners.

While various embodiments have been described above, it will be understood to those skilled in the art that the embodiments described are by way of example only. Accordingly, the disclosure described herein should not be limited based on the described embodiments.

What is claimed is:

1. A lighting apparatus comprising:
a driving circuit configured to provide a current path for sequential light emission of LED groups in response to changes of a rectified voltage;
a dimming control unit configured to provide one of first and second control signals as a dimming control signal, the first control signal corresponding to a dimming signal inputted in response to connection of a dimmer, the second control signal corresponding to disconnection of the dimmer; and
a driving current control circuit configured to control the amount of driving current flowing through the current path in response to the dimming control signal of the dimming control unit.

2. The lighting apparatus of claim 1, wherein the dimming control unit provides a preset constant voltage as the second dimming control signal.

3. The lighting apparatus of claim 1, wherein the dimming control unit provides a pulse signal having a preset constant pulse width as the second dimming control signal.

4. The lighting apparatus of claim 1, wherein the dimming control unit outputs the second dimming control signal at a level corresponding to the maximum value of the first dimming control signal.

5. The lighting apparatus of claim 1, wherein the dimming control unit comprises:
a first dimming control signal providing circuit configured to receive the dimming signal and provide the first dimming control signal corresponding to the level of the dimming signal; and
a second dimming control signal providing circuit configured to provide the second dimming control signal corresponding to a preset illuminance when the first dimming control signal is equal to or lower than a preset level, in response to disconnection of the dimmer.

6. The lighting apparatus of claim 1, wherein the dimming control unit comprises:
a first dimming control signal providing circuit configured to receive the dimming signal and provide the first dimming control signal corresponding to the level of the dimming signal;
a comparator configured to determine whether the first dimming control signal is equal to or lower than a preset reference voltage; and
a second dimming control signal providing circuit configured to provide the second dimming control signal corresponding to a preset illuminance when the first dimming control signal is equal to or lower than the reference voltage.

7. The lighting apparatus of claim 6, wherein the first dimming control signal providing circuit comprises a photo coupler to provide the first dimming control signal.

8. The lighting apparatus of claim 1, wherein the driving current control circuit comprises a current control element which is connected in series to a sensing resistor connected to a driving current output terminal of the driving circuit, and
the current control element controls the amount of driving current according to one of the first and second dimming control signals provided from the dimming control unit.

9. The lighting apparatus of claim 1, wherein the driving circuit controls the amount of driving current in the current path formed therein, according to the dimming control signal applied to a dimming control terminal, and
the driving current control circuit is connected to the dimming control terminal of the driving circuit, and transmits the dimming control signal of the dimming control unit to the dimming control terminal.

10. The lighting apparatus of claim 9, wherein the driving circuit comprises a dimming processing unit connected to a sensing resistor terminal which is commonly connected to switching circuits for selectively providing the current path in response to the sequential light emission of the LED groups, and
the dimming processing unit controls the amount of driving current to be outputted, in response to the dimming control signal.

11. The lighting apparatus of claim 9, wherein the driving circuit comprises a dimming processing unit configured to receive the dimming control signal and switching circuits configured to selectively provide the current path in response to the sequential light emission of the LED groups, and
the dimming processing unit controls the amounts of driving currents of the respective switching circuits for forming the current path in response to the dimming control signal.

12. The lighting apparatus of claim 9, wherein the driving circuit comprises a dimming processing unit configured to receive the dimming control signal and a reference voltage supply unit configured to provide a reference voltage for forming the current path in response to the sequential light emission of the LED groups, and
the dimming processing unit changes the level of the reference voltage of the reference voltage supply unit in response to the dimming control signal.
